(19) United States
(12) Patent Application Publication
(10) Pub. No.: US 2024/0401460 A1
(43) Pub. Date: Dec. 5, 2024

(54) DRILL STRING STICK/SLIP PREDICTION AND MITIGATION

(71) Applicant: Schlumberger Technology Corporation, Sugar Land, TX (US)

(72) Inventors: Soumya Gupta, Santa Clara, CA (US); Indranil Roychoudhury, Menlo Park, CA (US); Crispin Chatar, Menlo Park, CA (US); Alfredo De La Fuente, Menlo Park, CA (US); Jose R. Celaya Galvan, Menlo Park, CA (US); Prasham Sheth, Menlo Park, CA (US)

(21) Appl. No.: 18/697,789

(22) PCT Filed: Oct. 26, 2022
(86) PCT No.: PCT/US2022/047807

§ 371 Date: Apr. 2, 2024

Related U.S. Application Data
(60) Provisional application No. 63/271,890, filed on Oct. 26, 2021.

(51) Int. Cl. E21B 44/00; G01V 20/00

(52) U.S. Cl. CPC E21B 44/00; G01V 20/00; E21B 2200/20; E21B 2200/22

(57) ABSTRACT

A method includes generating one or more hybrid physics models each configured to predict a value for a drilling condition based on training data, training a machine learning model to predict a drilling condition severity based on the training data and the value of the drilling condition predicted by the one or more hybrid physics models, receiving sensor data representing present drilling data, predicting the drilling condition, based at least in part on the sensor data, using the hybrid physics model, and predicting the drilling condition severity, based at least in part on the drilling condition that was predicted and the sensor data, using machine learning model that was trained.

### CROSS-REFERENCE TO RELATED APPLICATIONS

This application claims priority to U.S. Provisional Patent Application having Ser. No. 63/271,890, which was filed on Oct. 26, 2021 and is incorporated herein by reference in its entirety.

### BACKGROUND

In the oilfield, wells are generally drilled by a bottom hole assembly (BHA) that includes a drill bit and is positioned at the distal end of a drill string. In many cases, the drill string is rotated from machinery at the surface. The rotation is transmitted via the drill string to the BHA, which causes the drill bit to rotate in the hole and advances the drill string. As the drill string is deployed, periodically, new “stands” (connections of two or more drill pipe joints) are connected to the drill string, extending the string and permitting continued deployment into the well.

Stick/slip is a phenomenon that may occur during such rotary drilling operations. Briefly, stick/slip is the slowing down or speeding up of the BHA that occurs when the energy generated by the rotary system on the drilling rig fails to reach the drill bit. The energy is stored in the form of rotation of the drill string, until it overcomes the friction on the BHA, at which point the BHA increases in speed so as to “unwind” the stored energy in the drill string. As a result, the BHA may periodically increase and decrease speed, and in extreme cases, this release of energy can cause the BHA to stop or even reverse the BHA rotation. This rotation variation can also damage downhole tools, stabilizers, and produce belled connections.

Stick/slip has been well studied in the art, and there are several options for avoiding it. Currently, one option is for wellsite personnel to manually adjust the weight on bit (WOB) and rotations per minute (RPM) to reduce stick/slip. This option is based on the experience of the personnel. There are also an array of analytical tools and techniques to reduce stick/slip. However, relying on the experience of individual operators can produce inconsistent results while drilling. Further, drilling operators generally do not react immediately to the potential for stick/slip, and, indeed, it may take time to adjust drilling parameters, even if the operators react quickly.

### SUMMARY

A method is disclosed, which includes generating one or more hybrid physics models each configured to predict a value for a drilling condition based on training data, training a machine learning model to predict a drilling condition severity based on the training data and the value of the drilling condition predicted by the one or more hybrid physics models, receiving sensor data representing present drilling data, predicting the drilling condition, based at least in part on the sensor data, using the hybrid physics model, and predicting the drilling condition severity, based at least in part on the drilling condition that was predicted and the sensor data, using machine learning model that was trained.

A computing system is disclosed, which includes one or more processors, and a memory system comprising one or more non-transitory computer-readable media storing instructions that, when executed by at least one of the one or more processors, cause the computing system to perform operations. The operations include generating one or more hybrid physics models each configured to predict a value for a drilling condition based on training data, training a machine learning model to predict a drilling condition severity based on the training data and the value of the drilling condition predicted by the one or more hybrid physics models, receiving sensor data representing present drilling data, predicting the drilling condition, based at least in part on the sensor data, using the hybrid physics model, and predicting the drilling condition severity, based at least in part on the drilling condition that was predicted and the sensor data, using machine learning model that was trained.

A non-transitory computer-readable medium is disclosed. The medium stores instructions that, when executed by at least one processor of a computing system is disclosed; cause the computing system to perform operations. The operations include generating one or more hybrid physics models each configured to predict a value for a drilling condition based on training data, training a machine learning model to predict a drilling condition severity based on the training data and the value of the drilling condition predicted by the one or more hybrid physics models, receiving sensor data representing present drilling data, predicting the drilling condition, based at least in part on the sensor data, using the hybrid physics model, and predicting the drilling condition severity, based at least in part on the drilling condition that was predicted and the sensor data, using machine learning model that was trained.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for generating a system that is configured to predict a drilling condition (e.g., stick-slip condition), according to an embodiment.

FIG. 3 illustrates a schematic view of a system of models, e.g., implementing the method 200 discussed above, according to an embodiment.

FIG. 4 illustrates another schematic view of the system, according to an embodiment.

FIG. 5 illustrates a more detailed view of the system, according to an embodiment.

FIG. 6 illustrates a schematic view of an example of a state-space model for stick-slip prediction in the form of a dynamic Bayesian network, according to an embodiment.

FIG. 7 illustrates a schematic view of two interacting submodels making up a state transition model of a hybrid physics model, according to an embodiment.

FIG. 8 illustrates shows a block diagram for a hybrid physics model, in which a state-space transition model and an observation model are modeled using a neural network, according to an embodiment.

FIG. 9 shows an internal structure of the LSTM and Gated Recurrent Unit (GRU).

FIG. 10A shows an RNN with a deterministic transition function fW (·) using W.

FIG. 10B illustrates a MarkovRNN with K states. Diamond and circle nodes represent deterministic and stochastic variables, respectively. The dashed line means sampling.

FIG. 11 illustrates a system diagram of MarkovRNN at each time step t. Boxes 1100 and 1102 are the discrete sample zt, while box 1104 denotes the selected state htk.

FIG. 12 illustrates a flowchart of a workflow 1200 for predicting stick-slip conditions while drilling stands of drill pipe, according to an embodiment.

FIG. 13 illustrates a conceptual view of a representation of predicted stick-slip severity, at different drilling setting combinations, over time, according to an embodiment.

FIG. 14 illustrates a schematic view of a computing system, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

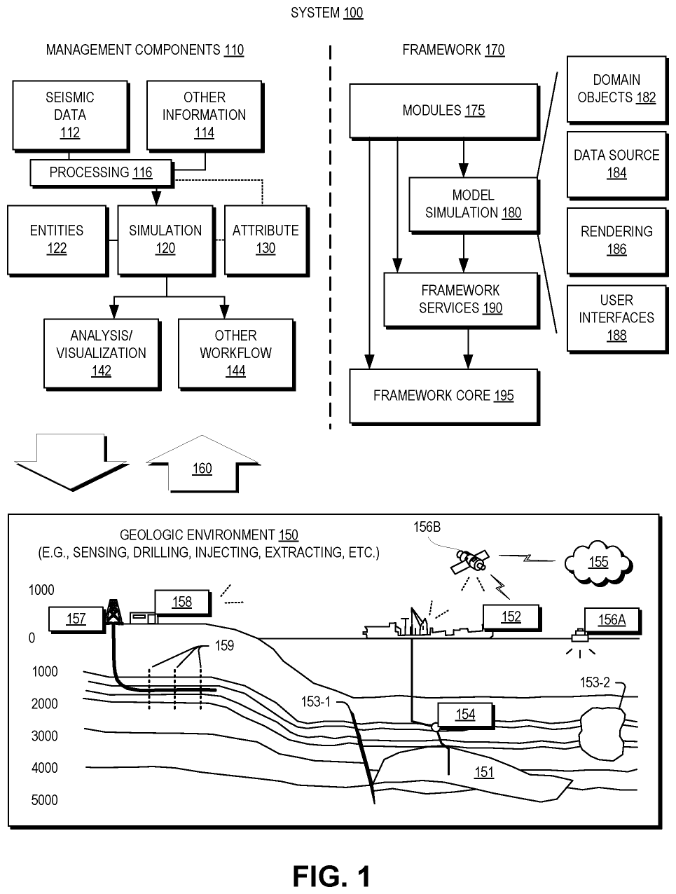

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

Embodiments of the present disclosure may be configured to predict stick/slip using surface and downhole sensors for the next stand of drilling. This may include predicting weight on bit (WOB) and speed (rotations per minute (RPM)) ranges associated with stick/slip classes and their probabilities. Embodiments may include a method that uses a physics-guided neural network (PGNN). The network leverages the physics models of drill string systems and reinforces it with machine-learning models, such as fully connected neural networks, recurrent neural networks (RNN) (e.g. long short-term memory (LSTM), and Markov Recurrent Neural Network (MarkovRNN)), and different ensembles of these approaches. Hence the method used is a hybrid of a physics based and a data-driven solution.

This method may permit an estimation of system response beyond the historical parameters, providing a better estimation of parameters for an operator going forward, e.g., on a stand-by-stand basis. This results in a more robust solution for the prediction. These predictions provide the drilling operator with an understanding of the different WOB and RPM ranges allowing operators to select parameter setpoints that transfer the maximum energy to the bit for rock destruction, without exciting the system into stick/slip. The ability to predict WOB and RPM ranges with associated stick/slip classes and their probabilities may be more valuable to a driller than the ability to predict slip/slip given a set of input parameters.

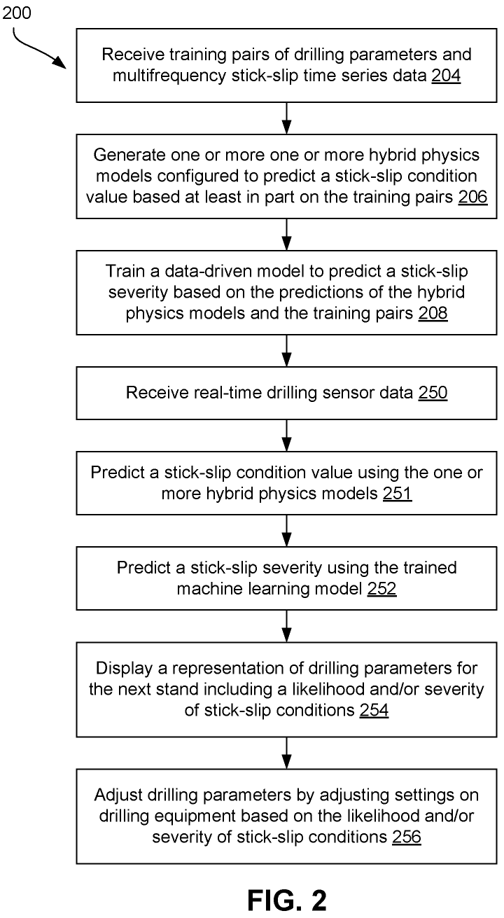

FIG. 2 illustrates a flowchart of a method 200 for generating a system that is configured to predict a drilling condition (e.g., stick-slip severity), according to an embodiment. Although the method 200 is discussed herein in terms of stick-slip severity prediction at a stand level, it will be appreciated that embodiments may be applied to any other drilling condition (e.g., disfunction) for which a physics model is available.

The method 200 may include receiving historical data (e.g., well logs) including drilling parameters and stick-slip conditions observed, which may be annotated as training pairs, as at 204. The historical data may be time-series data, and may include, for example, rotational speed measurements (generally at the BHA), which may be sampled at relatively high frequency, such as several times per second. By contrast, the time-series data may also include a value for stick-slip conditions as they was experienced while drilling a given stand of drill pipes. As the term is used herein, a “stand” of drill pipe can be one, two, three, or more drill pipes. If the stand includes two or more drill pipes, then these drill pipes have been assembled together prior to connecting the stand to a drill string. It is specifically contemplated herein, however, that the stand can be made up of a single drill pipe or any number of multiple drill pipes. The historical data may also include formation properties, well trajectory/geometry, etc., which may be used to inform the building of the models, discussed below.

The value for stick-slip conditions may include a quantitative measure of the amount of time that the BHA experiences stick slip while a given stand is being run (that is, the time spent drilling between when a given stand is connected to a drill string and when drilling is stopped so that another stand can be connected). The quantitative value may also or instead consider the speed variation at the BHA, or any other measures that may indicate a stick-slip severity. In some embodiments, the stick-slip severity can be stratified into qualitative “bins”, e.g., certain thresholds may be established separating the stick-slip conditions into stick-slip severity, e.g., low, medium, high, or severe, to name one specific example. Thus, it will be appreciated that there are at least two time-series data, with different frequencies. The first is the sensor measurement, which has a relatively high frequency, and the second is the stick-slip severity experienced while drilling a given stand. The frequency for the second measurement is based on the amount of time it took to run the stand into the well, and is thus indeterminate; that is, the time between members of the time series may be different for each pair of consecutive time series.

In order to provide the training pairs, raw historical data may be processed to remove noise captured in the sensors when, for example, the rig is not drilling. Furthermore, the preprocessing may narrow the focus of the operation to validating sensors while the systems are working and generating data. For example, some of the sensor data is either missing or are of dummy zero value when no drilling operation is being performed at the wellsite.

Vertical stands may be extracted from the depth data using a stand extraction algorithm. The data set consequently extracted using the stand extraction algorithm may then processed to include the timestep for each of the data points. The timestep is calculated as the difference between the earliest timestamp and the current timestamp. The data may also be annotated to convert the numerical stick/slip values into their corresponding severity classes. Thus, preprocessing may include, e.g., identifying, filtering, and cleansing sensor data.

Extracting vertical stands based on bit on bottom and slip status. Next, preprocessing may include annotating the data to convert the numerical stick/slip values into low, medium, high, and severe classes. Preprocessing may also include splitting the data into train and test sets based on geographical proximity.

Once preprocessed, the data set has the stands extracted from the well logs. These data are highly imbalanced, with ˜80% observations of stick-slip being in the low class, and less than 5% in the severe stick/slip class. Accordingly, the resolution of the classes may, in some embodiments, be reduced, such that there are fewer bins, so as to increase the balance.

The method 200 may also include predicting a value for a stick-slip condition using one or more hybrid physics models, based at least in part on the training pairs, as at 206. The hybrid physics models may be state models, which are configured to receive an observed variable and generate a state based thereon. The hybrid physics models may be a combination of at least two different types of models: a state transition model and an observation model. For example, five different hybrid physics models may be generated, as follows:

TABLE 1
Hybrid Physics Model Formation

| Model | State Transition Model | Observation Model |
|---|---|---|
| 1 | Ordinary differential | Algebraic equations |
| | equations | |
| 2 | Ordinary differential | Extreme gradient boosting |
| | equations | model |
| 3 | Fully connected neural | Fully connected neural |
| | network | network |
| 4 | Long short-term memory | Fully connected neural |
| | network | network |
| 5 | Markov recurrent neural | Fully connected neural |
| | network | network |

Each of the hybrid physics models may be configured to determine or “predict” stick-slip conditions, based on the input parameters. Additional information about the hybrid physics models is provided below, but it will be appreciated that the hybrid physics model may be a combination of two physics-based models (e.g., using equations of state, which may be built from models of the physical subsurface based on data gleaned from the field), two data-driven models (e.g., neural networks that are tuned to make predictions based on patterns of input data), or a combination thereof.

In some embodiments, the predicting workstep 206 may include generating the hybrid physics models, e.g., building the physics models and/or training the neural networks. In some embodiments, a single hybrid physics model may be employed, e.g., a single “shot”. However, in other embodiments, an ensemble of two or more such hybrid models may be employed. It will be appreciated that the physics-based models that do not employ a neural network may not be trained, while those that do, are trained using the training data, as part of generating the hybrid physics-based models.

In either case, a data-driven, machine-learning model may be trained, as at 208, to predict stick-slip conditions based on the training pairs and on the predictions from the one or more hybrid physics models. In the case that there are two or more hybrid physics models, the data-driven model may learn which of the hybrid physics models works best in what conditions, and provide more weight to the better-performing hybrid physics models, and less to others, given the conditions that are provided by the input drilling parameters. Accordingly, the machine-learning model (e.g., a neural network) may perform an ensembling of the predictions of the (e.g., five) different hybrid physics models, as well as make a data-driven prediction of stick-slip conditions.

These two activities, ensembling and predicting by the trained machine learning model, may not be discrete, but part of a complex action, or they may be a two-step process. In either case, the physics models may thus guide the neural network of the machine learning model. Moreover, the generating of the hybrid-physics model(s) and the machine learning model may each be iterative processes, which may be iterated simultaneously, e.g., by adjusting one or more of the hybrid phsyics models and/or the machine learning model based on an error between the stick-slip severity that is predicted and that observed in the historical, training data.

With the data-driven, machine learning model now trained, the method 200 may proceed to an operational or “inferencing” phase. As shown, the method 200 may include receiving real-time sensor data representing present drilling data, e.g., at least some of the same drilling parameters, as at 250. As noted above, the drilling parameters may include drilling equipment settings, such as rotational speed and/or WOB and/or any other data that may impact stick-slip predictions.

The method 200 may then include predicting one or more stick-slip values based on the sensor data, using the hybrid physics model(s), as at 251. The method 200 may also include predicting a stick-slip severity based on the sensor data and the one or more predicted stick-slip values, using the trained machine learning model, as at 252.

The method 200 may also include predicting stick-slip severity for a range of different drilling parameters for a next stand of drill pipe. The range of different drilling parameters may be an operating envelope for drilling equipment, e.g., in terms of rotational speed and WOB. Thus, for example, the method 200 may provide an expected stick-slip severity for different combinations of drilling parameters, so that an operator (whether human or automated) may determine what drilling parameters to choose or avoid, so as to mitigate stick-slip conditions.

The method 200 may also include displaying (visualizing) a representation of drilling parameters for the next stand, including the predicted stick-slip severity, as at 254. This may be referred to as a “drilling advisor”, as will be discussed in greater detail below. This representation may be viewable by a human operator, e.g., on a computer display, so that the operator can make a quick and accurate determination as to drilling parameters for a next stand. This stand-level frequency for selecting different drilling parameters is selected because drilling operations generally pause while a new stand is added to the string, thus providing a convenient point for a drilling operator to confirm or select different drilling settings.

The method 200 may also include adjusting one or more drilling parameters by adjusting one or more settings on drilling equipment based at least in part on the predicted stick-slip severity, as at 256. As noted above, this may be done by a human operator in response to viewing the drilling advisor display or may be done automatically by a computer that controls drilling equipment settings.

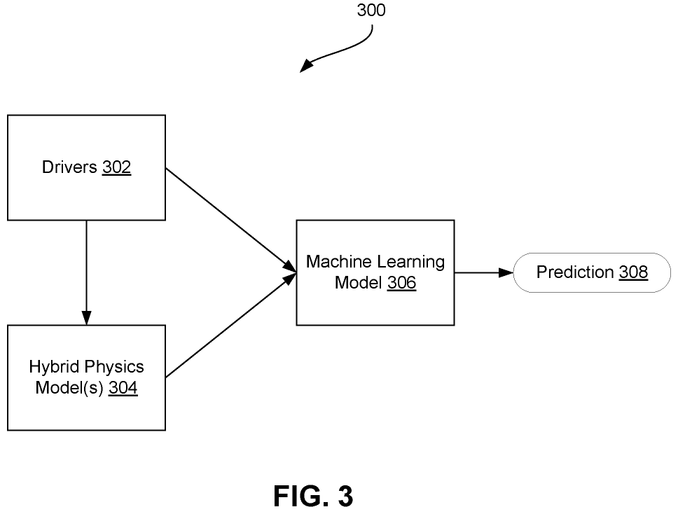

FIG. 3 illustrates a schematic view of a system 300 of models, e.g., implementing the method 200 discussed above, according to an embodiment. In particular, the system 300 may include drivers 302, e.g., input drilling parameters, formation properties, well trajectory, depth, geometry properties, etc. In the training stage, the drivers may also include the results, that is, stick-slip conditions and/or BHA rotation measurements, e.g., as dual-frequency time-series data. The drivers 302 may be fed to the hybrid physics model(s) 304. In the building stage, the hybrid physics model(s) 304 may be configured to predict a stick-slip value for a drill stand, and, if possible, the probability for different stick-slip conditions at different speeds and/or WOBs. The drivers 302 and the prediction from the hybrid physics model(s) 304 may be fed to a machine-learning model 306, which may be trained to make a data-driven determination of stick-slip conditions directly based on the drivers, and also based on the output from the hybrid physics based model(s) 304. The generating of the hybrid physics model(s) 304 and the machine learning model 306 may not be discrete, but may occur iteratively, together, by minimizing a loss function for each. Accordingly, the models 304, 306 may be jointly trained, e.g., simultaneously, rather than one being trained and then the other being trained.

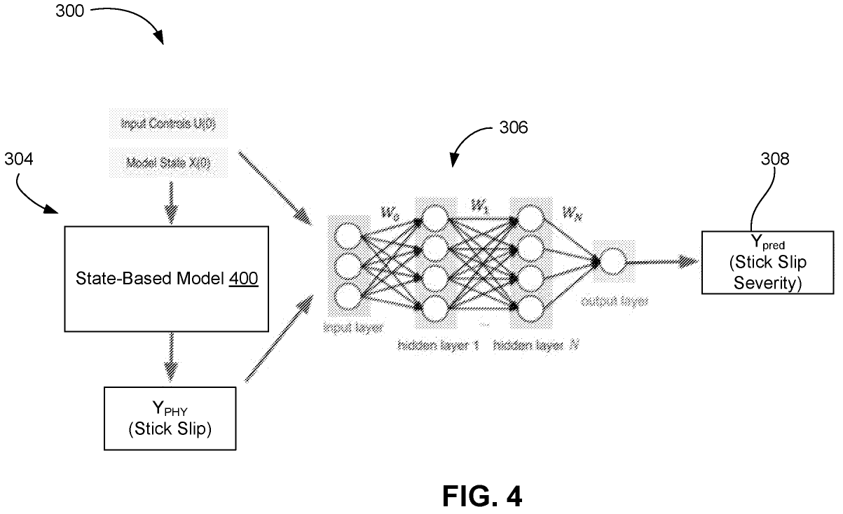

FIG. 4 illustrates another schematic view of the system 300, according to an embodiment. As discussed, the system 300 may include a hybrid physics model 304. In this embodiment, the hybrid physics model includes a state-space model 400 for stick-slip. A state-space model refers to a class of probabilistic graphical models that describes the probabilistic dependence between the latent state variable and the observed measurement. As noted above, the hybrid physics model 304 may include a state-transition model and an observation model. The state or the measurement can be either continuous or discrete. State-space modeling may compute an estimate of the hidden state, given the observed data (input controls U(0) and model state X(0)) using a state transition model and then using the hidden state to estimate the output variable using the observation model. The resulting output variable Y_{PHY}, along with the input controls (e.g., the input controls U(0) and model state X(0), e.g., the “drivers” 302 discussed above) may be provided to the data-driven, machine-learning model (e.g., a neural network) 306, from which the prediction 308 is made.

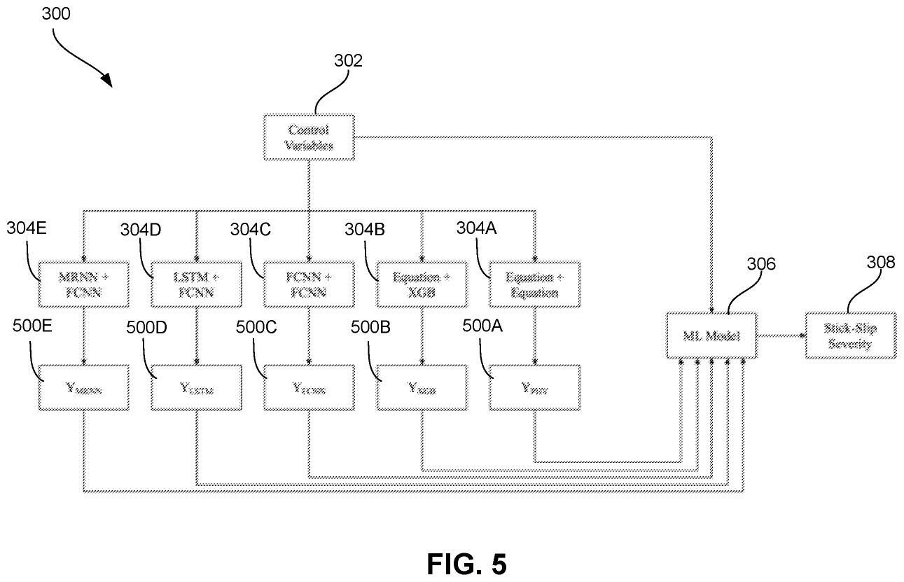

FIG. 5 illustrates a more detailed view of the system 300, according to an embodiment. As shown, the control variables (i.e., the drivers 302) are provided to five different hybrid physics models 304A, 304B, 304C, 304D, 304E, as an example. As shown, one of the models 304A is a physical equation-based model and the others 304B-E are empirical models learned by using data. Moreover, The different hybrid physics models 304A-E may arrive at different stick-slip predictions 500A, 500B, 500C, 500D, 500E, respectively. These predictions 500A-E may be fed, along with the drivers 302, to the machine learning model 306, which may be trained to make a prediction based on the combination of the drivers 302 and the predictions 500A-E.

The machine learning model 306 performs two tasks: (1) combine physics and machine learning together; and (2) ensemble the results of different models 304A-E into a single label. “Ensembling” in statistics and machine learning is a technique that allows for combining multiple models into one model to provide improved performance over any of the constituent models. This may capture the diversity of different models and use them together to improve the results of individual models. This approach helps to reduce the overall variance of the predictions.

In some embodiments, the machine learning model 306 may combine the quantitative results of different models to obtain a singular quantitative output that could be binned into appropriate classes (e.g., stratified into bins, as mentioned above). In other embodiments, the machine learning model may combine the quantitative results of different models to directly get the class label representing the severity of stick/slip using a classification model. Any type of neural network may be used in the machine learning model 306 as a classifier to combine the results from the different models 304A-E. After comparing the results from different individual models and the results after ensembling, the quality of the predictions after ensembling may be more accurate that of the individual models.

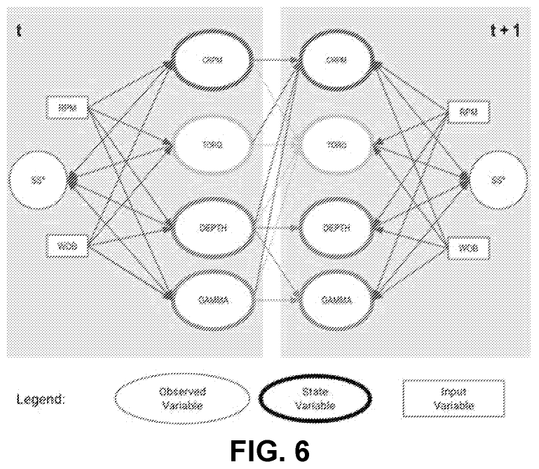

Turning now to the individual hybrid physics models 304, FIG. 6 illustrates a schematic view of an example of a state-space model (e.g., for use in the hybrid physics model 304) for stick/slip prediction in the form of a dynamic Bayesian network, according to an embodiment. In this formulation, the Collar RPM (CRPM), Torque (TORQ), Measured Depth (DEPTH), and Gamma-Ray (GAMMA) are the unknown hidden variables that would be estimated. RPM (surface rotational speed) and WOB are controllable input variables that are known at the individual worksteps. Finally, the stick/slip (SS) is an observed measured variable, also known in the process.

The state-space formulation may be at least partially derived from first principles, and while the state-transition model may be defined using differential equations, the observation model may be defined using algebraic equations. The source of these equations is domain knowledge. For the sake of time efficiency, however, the time-consuming process of modeling the first principles can be at least partially avoided by generating the state-transition and observation models empirically from data. As noted above in Table 1, five different hybrid physics models (state-space models for predicting stick/slip) can be produced, each with a different representation for the state-transition and observation models. These five state-space models listed in Table 1 are as follows:
State-Space Model 1: Both state-transition and observation models are represented using physics equations.
State-Space Model 2: The state-transition model is represented using physics equations, while the observation model is represented using an XGBoost algorithm.
State-Space Model 3: Both the state-transition and observation models are represented using fully connected neural networks.
State-Space Model 4: The state-transition model is represented by an LSTM and the observation model is represented using a fully connected neural network.
State-Space Model 5: The state-transition model is represented using a MarkovRNN and the observation model is represented again using a fully connected neural network.

### State-Space Model 1: Differential Equations-Based State-Transition and Algebraic Equations-Based Observation Model.

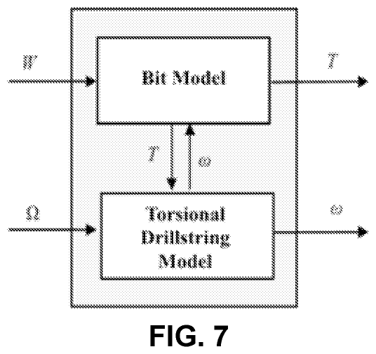

The first model includes two interacting submodels shown in FIG. 7. These two models are a torsional drillstring dynamics model in which the drillstring is modeled as a mechanical oscillator with one rotational degree of freedom, and a Bit-Rock interaction model where the bit model presents a relation between applied WOB, W, and the resulting torque on the bit T at a given RPM ω.

The inputs to this model are the surface angular velocity and the torque, and the output is the downhole angular velocity. The gamma ray is included as one of the features to identify the occurrence of the stick/slip. As a result, the model is modified. That is, based on the drillstring model using the first principles, a system of equations was established to combine the torsional drillstring dynamics model and the bit rock interaction model. Using the equations requires estimating the appropriate constants and then using them to estimate the quantitative stick/slip value, which could be binned into the appropriate categories to identify the stick/slip severity.

$$dt ( t ) = dt ( t ) \cdot {10}^{- 5}$$

$$μ ( t ) = a 1 \cdot exp ( \frac{\vert ω ( t ) \vert}{a 3} )$$

$$α ( t + 1 ) = ( ω ( t ) - RPM ( t ) ) \cdot dt ( i ) + α ( t )$$

$$torque ( t + 1 ) = ( μ ( t ) \cdot WOB ( t ) \cdot \frac{{D}_{B}}{3} ) \cdot dt ( t ) + torque ( t )$$

$$ω ( t + 1 ) = ( - 2 \cdot D \cdot {ω}_{0}^{2} \cdot ( ω ( t ) - RPM ( t ) ) - {ω}_{0}^{2} α ( t ) - \frac{torque ( t )}{J} ) \cdot dt ( t ) + ω ( t )$$

$$depth ( t + 1 ) = a 2 \cdot RPM ( t ) \cdot WOB ( t ) \cdot dt ( t ) + depth ( t )$$

$$gamma ( t + 1 ) = a 3 \cdot RPM ( t ) \cdot WOB ( t ) \cdot depth ( t ) \cdot dt ( t ) + gamma ( t )$$

$$Stick / Slip ( t ) = \vert ( a 4 \cdot RPM ( t ) - a 5 \cdot ω ( t ) ) \cdot a 6 \vert$$

$$y = [ Stick / Slip ]$$

where m represents friction, w represents downhole RPM, and a=w-downhole RPM.

### State-Space Model 2: Differential Equations-Based State-Transition and XGBoost-Based Observation Model.

The second state-space model uses the same differential equations discussed above with respect to State-Space Model 1; however, instead of the algebraic equations, this model uses the XGBoost algorithm (or another neural network) to generate the observation model. In this observation model, the output is combined from the established state-transition model system, based on the state-space model equations adapted from the first principles drill string model by treating it as an input for the XGBoost model. The XGBoost model in this case is used as a regression model, which predicts the quantitative value of stick/slip. This model permits avoiding estimating the constants for the observation model. Because the output of the observation model directly influences the quality of the predictions, the XGBoost model allows for a more generalized model, which removes the error caused by the poor estimation of the constants in the observation model.

### State-Space Model 3: Neural Network-Based State-Transition and Neural Network-Based Observation Model.

Artificial neural networks that are based on biological neural networks are a machine learning technique used for classification and various other purposes. The artificial neural networks contain artificial neurons programmed to perform various calculations based on the input they receive from other neurons. Neural networks can learn any function based on data using techniques such as gradient descent, once the model is tuned to capture the complexity of the problem in an appropriate way.

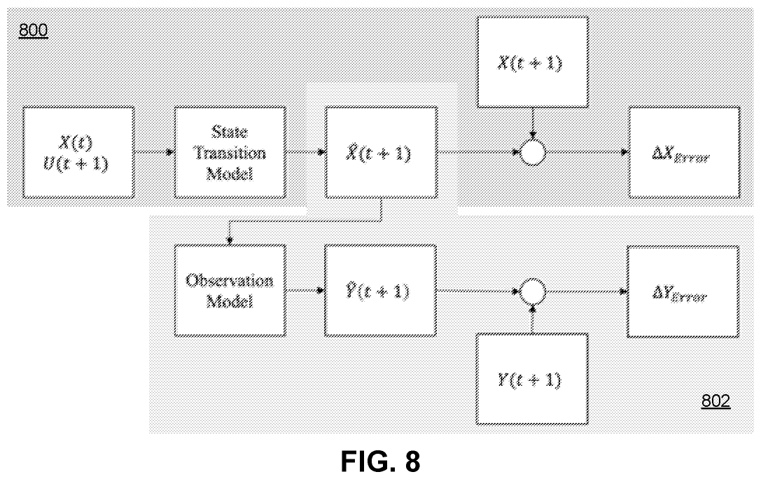

The third state-space model was formulated using neural networks. Instead of using the first principles and boosting algorithm neural network, an empirical representation is used for both the state-transition and observation model. FIG. 8 illustrates shows a block diagram for such a formulation in which a state-space transition model 800 and observation model 802 are modeled using a neural network. This formulation enables the end-to-end training of the state-space model 800. The error is propagated back from the observation model 802 to the state transition model, and both can be jointly trained. The total loss from both models is used for the joint training of the models 800, 802. The two neural networks are modular and can be used as blocks in addition to being combined with different models.

### State-Space Model 4: LSTM-Based State-Transition and Neural Network-Based Observation Model.

Recurrent Neural Network (RNN) is a neural network model that takes feedback in the form of the neuron output from the previous layers into consideration when calculating the output of the current layer. Hence, the previous layer's output becomes an input for the current layer. This feedback consideration mechanism makes the network naturally suitable for processing time-series and other sequential data. Embodiments of the present disclosure may use depth series data in addition to the RNNs to model the state transition model for the state-space formulation by considering and working particularly with two variants of RNN, i.e., LSTM and MarkovRNN.

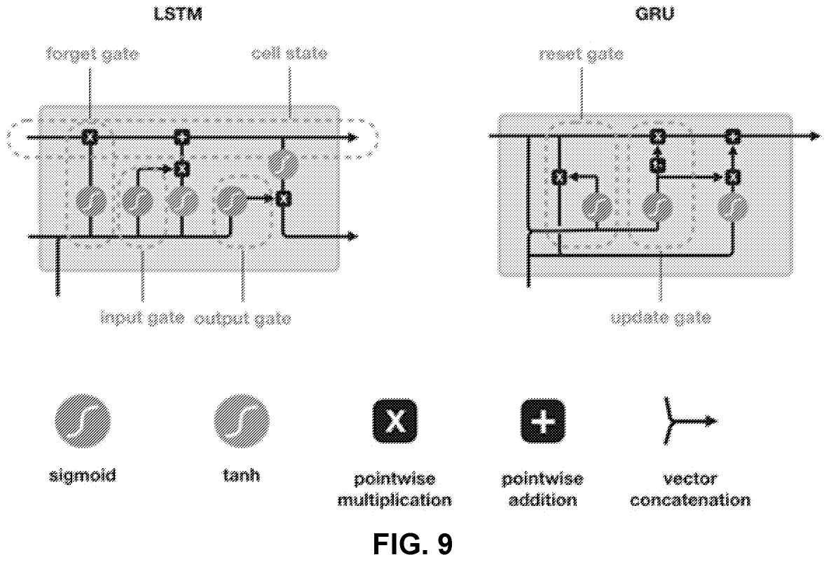

LSTM networks are a special kind of RNN, capable of learning long-term dependencies. LSTMs with their special structure consisting of gates can capture long-term trends of the sequential data. These networks can remove or add information to the cell state by these regulated structures called gates. FIG. 9 shows an internal structure of the LSTM and Gated Recurrent Unit (GRU).

In the state-space formulation with neural networks, LSTM was used in place of the neural network to be the empirical representation of the state transition model. Because of its inherent architecture, LSTM can capture the sequential trends from the data and use it constructively to enhance the state-transition model. A fully connected neural network-based observation model may be coupled with the LSTM-based state transition model. Two different training strategies were attempted with this configuration, e.g., training both models separately and joint training of both models. Using separate training may have lower complexity while training, which helps save resources in terms of computation power and time required for training. Joint training may provide an improved set of predictions because the weights in the state transition model are coupled with those in the observation model. As a result, end-to-end training allows for reducing the overall error by adjusting the weights in both models to overcome the limitations of each other.

State-transition and observation models may additionally be tuned to find an appropriate setting for the number of LSTM cells as well as for the configuration of fully connected layers following the LSTM units. Moreover, regularization techniques to include dropout and batch-normalization in the network may also be employed.

### State-Space Model 5: MarkovRNN-Based State-Transition and Neural Network-Based Observation Model.

The MarkovRNN may enhance latent variable representation learned by LSTM by discovering the Markov state transitions in sequential data based on a K-state LSTM model. In general, RNNs dynamically calculate the latent features and propagate the hidden state at each time step. The sequential architecture allows for summarization of the history information from the past inputs {x1, . . . , xt−1} and adopts the information to predict the next sequential output yt, conditioned on the current input xt and the previously established hidden state ht−1. This setting allows the RNNs to include memory-based functionality, allowing it to capture sequential trends in the data. However, in the case of real-life stochastic processes, the dependence of a single stream of hidden variables can restrict the model's capability to learn and gain the required complexity to capture the existing complex trends in the data. The stochastic transitions in RNNs by incorporating the Markov property with discrete random variables allow the user to handle highly structured sequential data with complicated latent information.

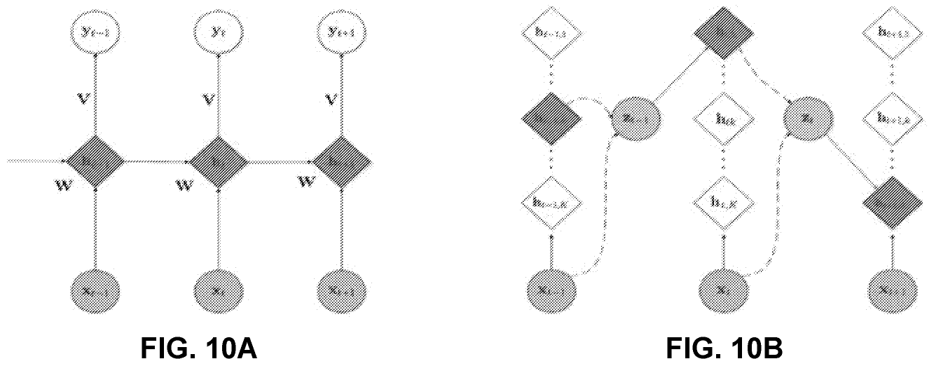

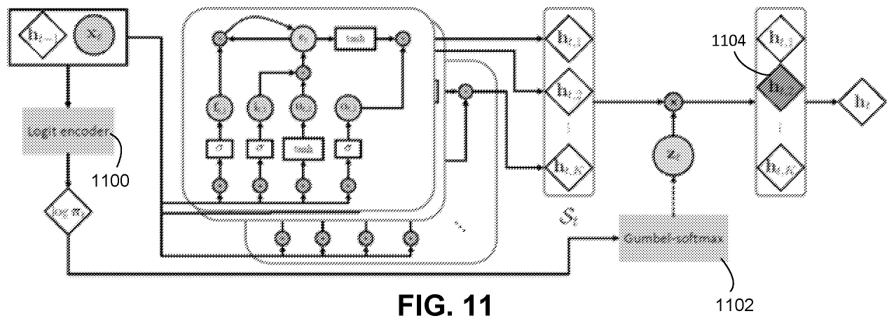

FIGS. 10A, 10B, and illustrate schematic views of a MarkovRNN, according to an embodiment. In particular, FIG. 10A shows an RNN with a deterministic transition function fW (·) using W. FIG. 10B illustrates a MarkovRNN with K states. Diamond and circle nodes represent deterministic and stochastic variables, respectively. The dashed line means sampling. FIG. 11 illustrates a system diagram of MarkovRNN at each time step t. Boxes 1100 and 1102 are the discrete sample zt, while box 1104 denotes the selected state htk.

The MarkovRNN has been used in an equivalent method to LSTM wherein the MarkovRNN replaces LSTM for the empirical state transition model and is coupled by a fully connected neural network as the observation model. For the MarkovRNN also, experiments with the two training settings were conducted. Consistent results were obtained where the jointly trained models' prediction results are improved as opposed to those from the separately trained models at the cost of the more complex training procedure and the computation cost to backpropagate the error throughout both the models.

The MarkovRNN architecture was further tuned to obtain an appropriate setting for the number of LSTM networks, number of cells in each LSTM network as well as for finding the appropriate configuration for fully connected layers following the MarkovRNN. Moreover, regularization techniques to include dropout and batch-normalization in the network were also considered in the experiments.

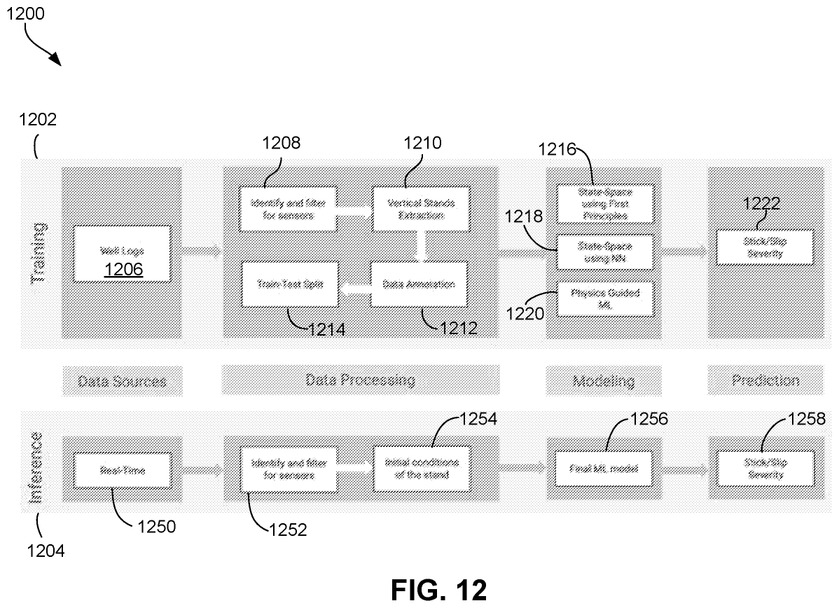

FIG. 12 illustrates a flowchart of a workflow 1200 for predicting stick-slip conditions while drilling stands of drill pipe, according to an embodiment. The workflow 1200 may have a “training” phase 1202 and an inference phase 1204. The training phase 1202 may include receiving drilling information taken from well logs 1206 from offset wells. This training data may then be processed (“preprocessed” as described above). As shown, such preprocessing in the workflow 1200 may include identifying and filtering for sensors, as at 1208, extracting vertical stand data 1210, annotating 1212 stick-slip conditions, and splitting 1214 the data into a training portion and a testing portion.

The preprocessed data may then be use for modeling, e.g., one or more hybrid physics models may be generated, including a state-space model generated using first principles at 1216 and a state-space model using neural networks 1218. The hybrid physics models may be configured to predict a stick-slip value for a next stand. As noted above, the one or more hybrid physics models may include a neural network, while one or more of the hybrid physics models may not. Those hybrid physics models that do not include a neural network are not trained, but otherwise generated, while those that do are trained.

A physics-guided machine learning model 1220 may also be trained to ensemble results from the hybrid physics models and to generate data-driven predictions of stick-slip severity based on drilling parameters. A resulting stick-slip severity prediction 1222 may be used to train the various different models, e.g., simultaneously, based on observational data from the well logs.

The inferencing phase 1204 may refer to the implementation of the now-trained models. In particular, real-time sensor data may be received at 1250. This real-time sensor data may be preprocessed so as to identify and filter for sensors at 1252 and determine initial conditions of the stand 1254. The filtered data may be fed to the hybrid physics models and to the machine learning model 1256, which may then predict stick-slip severity, as at 1258.

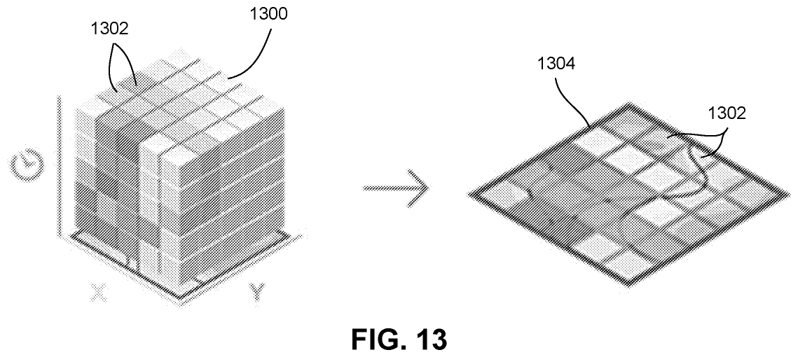

FIG. 13 illustrates a conceptual view of a representation of predicted stick-slip severity, at different drilling setting combinations, over time, according to an embodiment. On the left, the representation is depicted as a cube 1300 of cells 1302, which can be compressed, as shown on the right, into a plane 1304 of cells 1302. For example, there may be two drilling settings, e.g., rotation speed (RPM) and WOB, which are provided as the X and Y axes, respectively. A third variable, time, is presented in the Z axis in the cube 1300. For ease of viewing by an operator, the cube 1300 can be compressed, as shown, into the two-dimensional plane 1304, so that stick-slip conditions are predicted for the entire next stand at the different drilling settings, rather than at instances during drilling the stand. The compression may be performed considering each cell corresponding to the different WOB and RPM combinations and has a label associated with it representing the severity of the stick/slip. Thus, based on this grid, drillers can be guided to identify the zones with the possibility of extreme stick/slip severity, which should be avoided during drilling operations. The stick-slip severity can be shown in the representation, e.g., using different colors, shading, hatching/texture, etc. Further, the stick-slip severity plane 1304 can be calculated and presented before each new stand is added.

Embodiments of the present disclosure thus provide an approach for predicting stick/slip for an upcoming drilling window. It will be appreciated that this approach is not limited to the specific problem of stick-slip prediction, but can be implemented for any other drilling disfunction and where physics models exist.

Decomposing the problem/solution space into a physics-based drill string model and data-driven machine-learning models reveal an alternative solution to this problem. While one-shot classification can predict stick/slip, it cannot offer the driller useful information in a timely manner to apply a real time solution. The hybrid method allows for an estimation of system response beyond the historical parameters, permitting an improved estimation of parameters. Furthermore, predicting for a fixed period ahead allows for decision making at intervals. The choice of breaking it down into stands is merely an example.

The physics model can be refined to enhance the equations and improve parameter estimation, implement sequential updates, and predict a procedure for stick/slip prediction. This process may be balanced with computing power and calculation time.

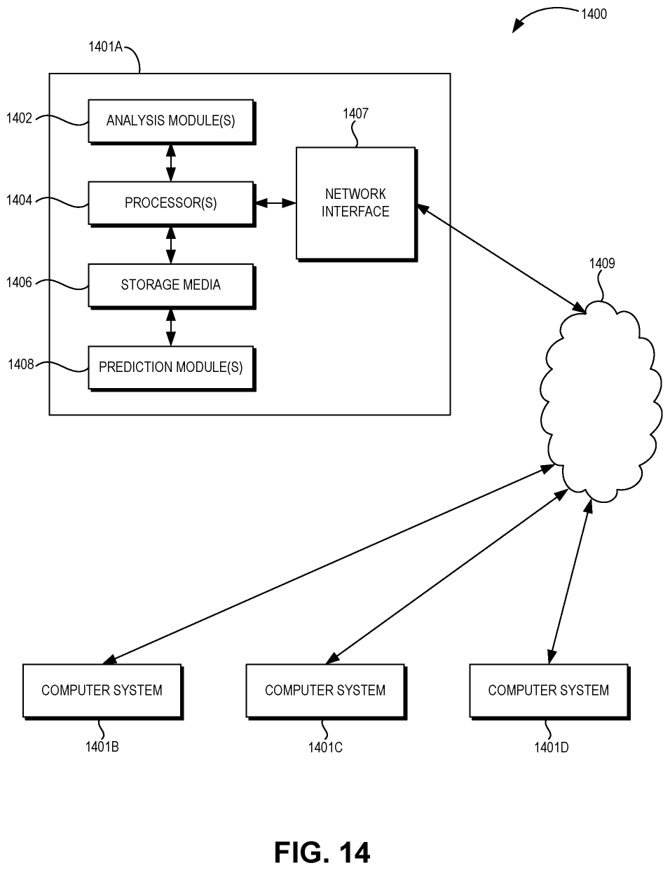

In some embodiments, the methods of the present disclosure may be executed by a computing system. FIG. 14 illustrates an example of such a computing system 1400, in accordance with some embodiments. The computing system 1400 may include a computer or computer system 1401A, which may be an individual computer system 1401A or an arrangement of distributed computer systems. The computer system 1401A includes one or more analysis modules 1402 that are configured to perform various tasks according to some embodiments, such as one or more methods disclosed herein. To perform these various tasks, the analysis module 1402 executes independently, or in coordination with, one or more processors 1404, which is (or are) connected to one or more storage media 1406. The processor(s) 1404 is (or are) also connected to a network interface 1407 to allow the computer system 1401A to communicate over a data network 1409 with one or more additional computer systems and/or computing systems, such as 1401B, 1401C, and/or 1401D (note that computer systems 1401B, 1401C and/or 1401D may or may not share the same architecture as computer system 1401A, and may be located in different physical locations, e.g., computer systems 1401A and 1401B may be located in a processing facility, while in communication with one or more computer systems such as 1401C and/or 1401D that are located in one or more data centers, and/or located in varying countries on different continents).

A processor may include a microprocessor, microcontroller, processor module or subsystem, programmable integrated circuit, programmable gate array, or another control or computing device.

The storage media 1406 may be implemented as one or more computer-readable or machine-readable storage media. Note that while in the example embodiment of FIG. 14 storage media 1406 is depicted as within computer system 1401A, in some embodiments, storage media 1406 may be distributed within and/or across multiple internal and/or external enclosures of computing system 1401A and/or additional computing systems. Storage media 1406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1400 contains one or more prediction module(s) 1408. In the example of computing system 1400, computer system 1401A includes the prediction module 1408. In some embodiments, a single prediction module may be used to perform some aspects of one or more embodiments of the methods disclosed herein. In other embodiments, a plurality of prediction modules may be used to perform some aspects of methods herein.

It should be appreciated that computing system 1400 is merely one example of a computing system, and that computing system 1400 may have more or fewer components than shown, may combine additional components not depicted in the example embodiment of FIG. 14, and/or computing system 1400 may have a different configuration or arrangement of the components depicted in FIG. 14. The various components shown in FIG. 14 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1400, FIG. 14), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method, comprising:
generating one or more hybrid physics models each configured to predict a value for a drilling condition based on training data;
training a machine learning model to predict a drilling condition severity based on the training data and the value of the drilling condition predicted by the one or more hybrid physics models;
receiving sensor data representing present drilling data;
predicting the drilling condition, based at least in part on the sensor data, using the hybrid physics model; and
predicting the drilling condition severity, based at least in part on the drilling condition that was predicted and the sensor data, using machine learning model that was trained.

2. The method of claim 1, wherein generating the one or more hybrid physics models and training the machine learning model occur simultaneously.

3. The method of claim 1, further comprising visualizing the drilling condition severity at a plurality of different drilling settings, wherein a drilling setting is selected based at least in part on the visualizing.

4. The method of claim 1, wherein the one or more hybrid physics models comprises a plurality of physics models, each including a state transition model and a state observation model.

5. The method of claim 1, wherein the one or more hybrid physics models are configured to receive a speed parameter (RPM) and a weight-on-bit parameter (WOB) and estimate hidden state variables comprising Collar RPM (CRPM), Torque (TORQ), Measured Depth (DEPTH), and Gamma-Ray (GAMMA).

6. The method of claim 5, wherein generating the one or more hybrid physics models comprises training the plurality of physics models that include a neural network.

7. The method of claim 6, wherein the plurality of hybrid physics models comprises:
a first model comprising:
a state transition model comprising ordinary differential equations; and
an observation model comprising algebraic equations;
a second model comprising:
a state transition model comprising ordinary differential equations; and
an observation model comprising an extreme gradient boosting model;
a third model comprising:
a state transition model comprising a fully connected neural network; and
an observation model comprising a fully connected neural network;
a fourth model comprising:
a state transition model comprising a long short-term memory network; and
an observation model comprising a fully connected neural network; and
a fifth model comprising:
a state transition model comprising a Markov recurrent neural network; and
an observation model comprising a fully connected neural network.

8. The method of claim 1, wherein the drilling condition comprises a stick-slip condition, and wherein predicting comprises predicting the drilling condition severity for a next stand of drill pipes to be added to a drill string.

9. The method of claim 1, wherein predicting the drilling condition comprises:
predicting the drilling condition severity for a plurality of drilling settings for the next stand; and
selecting a drilling setting from the plurality of drilling settings based at least in part on the predicted drilling condition severity.

10. A computing system, comprising:
one or more processors; and
a memory system comprising one or more non-transitory computer-readable media storing instructions that, when executed by at least one of the one or more processors, cause the computing system to perform operations, the operations comprising:
generating one or more hybrid physics models each configured to predict a value for a drilling condition based on training data;
training a machine learning model to predict a drilling condition severity based on the training data and the value of the drilling condition predicted by the one or more hybrid physics models;
receiving sensor data representing present drilling data;
predicting the drilling condition, based at least in part on the sensor data, using the hybrid physics model; and
predicting the drilling condition severity, based at least in part on the drilling condition that was predicted and the sensor data, using machine learning model that was trained.

11. The computing system of claim 10, wherein generating the one or more hybrid physics models and training the machine learning model occur simultaneously.

12. The computing system of claim 10, wherein the one or more hybrid physics models comprises a plurality of physics models, each including a state transition model and a state observation model.

13. The computing system of claim 12, wherein generating the one or more hybrid physics models comprises training the plurality of physics models that include a neural network.

14. The computing system of claim 13, wherein the plurality of hybrid physics models comprises:
a first model comprising:
a state transition model comprising ordinary differential equations; and
an observation model comprising algebraic equations;
a second model comprising:
a state transition model comprising ordinary differential equations; and
an observation model comprising an extreme gradient boosting model;
a third model comprising:
a state transition model comprising a fully connected neural network; and
an observation model comprising a fully connected neural network;
a fourth model comprising:
a state transition model comprising a long short-term memory network; and
an observation model comprising a fully connected neural network; and
a fifth model comprising:
a state transition model comprising a Markov recurrent neural network; and
an observation model comprising a fully connected neural network.

15. The computing system of claim 10, wherein the drilling condition comprises a stick-slip condition, and wherein predicting comprises predicting the drilling condition severity for a next stand of drill pipes to be added to a drill string.

16. The computing system of claim 10, wherein predicting the drilling condition comprises:
predicting the drilling condition severity for a plurality of drilling settings for the next stand; and
selecting a drilling setting from the plurality of drilling settings based at least in part on the predicted drilling condition severity.

17. A non-transitory computer-readable medium storing instructions that, when executed by at least one processor of a computing system, cause the computing system to perform operations, the operations comprising:
generating one or more hybrid physics models each configured to predict a value for a drilling condition based on training data;
training a machine learning model to predict a drilling condition severity based on the training data and the value of the drilling condition predicted by the one or more hybrid physics models;
receiving sensor data representing present drilling data;
predicting the drilling condition, based at least in part on the sensor data, using the hybrid physics model; and
predicting the drilling condition severity, based at least in part on the drilling condition that was predicted and the sensor data, using machine learning model that was trained.

18. The medium of claim 17, wherein the one or more hybrid physics models comprises a plurality of physics models, each including a state transition model and a state observation model.

19. The medium of claim 17, wherein the drilling condition comprises a stick-slip condition, and wherein predicting comprises predicting the drilling condition severity for a next stand of drill pipes to be added to a drill string.

20. The medium of claim 17, wherein predicting the drilling condition comprises:
predicting the drilling condition severity for a plurality of drilling settings for the next stand; and
selecting a drilling setting from the plurality of drilling settings based at least in part on the predicted drilling condition severity.
